(19) United States
(12) Patent Application Publication
(10) Pub. No.: US 2025/0316122 A1
(43) Pub. Date: Oct. 9, 2025

(54) SYSTEMS, APPARATUS, AND METHODS FOR ACCESS RESOLUTION BASED ON SITUATIONAL AWARENESS

(71) Applicant: Dunn, Inc., Sunnyvale, CA (US)

(72) Inventors: Herman Yau, Sunnyvale, CA (US); Frederik Delacourt, Celina, TX (US)

(73) Assignee: Durin, Inc., Sunnyvale, CA (US)

(21) Appl. No.: 19/171,017

(22) Filed: Apr. 4, 2025

Related U.S. Application Data
(60) Provisional application No. 63/574,418, filed on Apr. 4, 2024.
(60) Provisional application No. 63/753,435, filed on Feb. 3, 2025.

(51) Int. Cl. G07C 9/37

(52) U.S. Cl. CPC G07C 9/37

(57) ABSTRACT

Systems, apparatus, and methods for access resolution based on situational awareness. The system adapts to the behaviors of users and provide more secure, more natural operation. Unlike existing solutions that are focused on a single factor/multi-factor authentication and binary outcomes (grant/deny), the exemplary “physical access resolution” system assesses the entire access event (not just identity) and may responsively launch multiple resolutions at points throughout the access event (not just a binary decision). Various entities employ layers of abstraction and integration between logical layers to allow for integration across nodes. Information collection may be staged and handled with varying levels of privacy protections. Access resolution may be implemented according to multi-modal and/or confidence-based metrics.

### PRIORITY

This application claims the benefit of priority to U.S. Provisional Patent Application Ser. No. 63/574,418 filed Apr. 4, 2024, and entitled “SYSTEMS, APPARATUS, AND METHODS FOR ACCESS RESOLUTION BASED ON SITUATIONAL AWARENESS”, and 63/753,435 filed Feb. 3, 2025, and entitled “SYSTEMS, APPARATUS, AND METHODS FOR STATE-BASED ACCESS RESOLUTION”, each of the foregoing incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of physical access control and building security. The disclosure is primarily discussed in reference to residential applications, but the techniques have broad applicability to commercial applications as well.

### DESCRIPTION OF RELATED TECHNOLOGY

In recent years, “smart” locks have become increasingly popular. Smart locks can be controlled remotely via smartphones or other devices, allowing homeowners to monitor and manage access to their properties more conveniently. Typically, these devices are designed to be installed at the entrance of a home or building, allowing users to see and communicate with visitors remotely through a smartphone app. When someone rings the doorbell or triggers the motion sensors, the camera activates, sending live video and audio to the user's device.

Most automatic locking uses e.g., user input, user device proxy input, or schedule-based behaviors. User input implementations often require a user to touch/push a designated button on the smart lock to explicitly signal intent. The lock then actuates the mechanical locking. Alternative solutions may use a device as a proxy for the user; for example, a smart phone can use RF signal strength and/or geofencing to detect when the user travels beyond a predefined zone, this triggers actuation of the lock. Schedule-based locking allows the user to define a schedule (via a smart lock app) to schedule automatic locking conditions e.g., an unlocked door may wait a duration before automatically locking.

### BRIEF DESCRIPTION OF THE DRAWINGS

FIG. 1 is a logical block diagram of a physical access resolution system, in accordance with various aspects of the present disclosure.

FIG. 2 is a logical block diagram of different proximity zones for use with a multi-staged pipeline of the physical access resolution system, in accordance with various aspects of the present disclosure.

FIG. 3 is a graphical representation of an exemplary egress (exit) scenario, useful to illustrate various aspects of the present disclosure.

FIG. 4 is a graphical representation of an exemplary “duress code” scenario, useful to illustrate various aspects of the present disclosure.

FIG. 5 is a graphical representation of an exemplary interior parcel drop-off scenario, useful to illustrate various aspects of the present disclosure.

FIG. 6 is a logical block diagram of one system for access resolution based on situational awareness, in accordance with various aspects of the present disclosure.

FIG. 7 is a logical block diagram of one generalized physical access resolution device.

FIG. 8 is a logical block diagram of one generalized system administration logic.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Access Control

Typically, “physical access control” refers to security techniques for managing entry to physical spaces such as buildings, rooms, and facilities. This can include security measures like keycards, biometric scanners, turnstiles, as well as security guards, surveillance cameras, etc. In many cases, these mechanisms are designed to authorize and authenticate individuals, devices, or entities before granting them entry or permission to the physical space.

“Authentication” refers to the act of verifying the identity of users or entities seeking access. Common authentication methods include passwords, PINs (personal identification number), biometric data (such as fingerprints or facial recognition), security tokens, smart cards, and digital certificates. So-called “multi-factor” authentication techniques use multiple “factors” to authenticate access for a user; for example, multi-factor authentication may use a login and password that triggers a secret code to be sent to a pre-registered device (like a phone). Multi-factor authentication typically uses multiple distinct factors, that all must succeed. While this provides extra security, it also increases user experience “friction” (i.e., it is less convenient for the user).

Another common authentication technology is so-called “multi-option, single path” smart locks (pin codes, fingerprint, face recognition). These solutions allow the user to select a single factor that best suits their lifestyle. In other words, the user can choose to use a physical key, a pin code, a digital key (their phone), or a biometric (their fingerprint). The user can even choose to use different options at different times for convenience. Importantly, these solutions select one single-factor authentication of multiple options-in other words, the individual factors are not used together.

Once a user or entity is authenticated, access control systems determine the level of access or permissions they are granted based on predefined policies and rules. Authorization ensures that users can only access resources or perform actions that are appropriate for their roles or privileges. As but one such example, a user may be authenticated as an employee, but they may only be authorized to access certain areas of the building.

Recently, there's been significant consumer interest in physical access control for residential applications. So called “smart locks” are now commonly marketed to homeowners. Smart locks often incorporate digital technologies with existing door locks-for example, a person may key in their PIN code to open the door. In some cases, smart locks may also incorporate cameras and have remote lock/unlock capabilities.

Conventional solutions for residential applications are focused on cost-effective protection. They leverage existing commercial technologies but often reduce scale and complexity. Unfortunately, while cost is important, conventional physical access control solutions have overlooked many of the unique aspects to residential life. For example, conventional solutions have not historically needed to address children, pets, the elderly, and/or disability-friendly access. As but one such example, young children may have difficulty remembering and/or entering a PIN code. As another example, a caretaker of an elderly relative with dementia may want to be alerted when their ward attempts to leave (and/or control their egress). A person that suffers from sleepwalking may want to lock themselves in at night. Pet doors are also problematic—in some cases, raccoons and other unwanted pests may learn to use them. In other words, residential applications have a variety of different concerns that are currently not addressed by available solutions.

### 2 Physical Access Resolution Overview

New solutions that adapt to the behaviors of users and provide more secure, more natural operation are needed. Conceptually, exemplary embodiments of the present disclosure take a broader view of “access control” than conventional approaches. Unlike existing solutions that are focused on a single factor/multi-factor authentication and binary outcomes (grant/deny), the exemplary “physical access resolution” system assesses the entire access event (not just identity) and may responsively launch multiple resolutions at points throughout the access event (not just a binary decision). To be more precise, the exemplary access resolution techniques make access decisions based on identity in a situational context (versus access control based on identity alone).

The exemplary physical access resolution system has multiple distinct aspects, discussed in greater detail below.

### 2.1 Abstraction and Integration

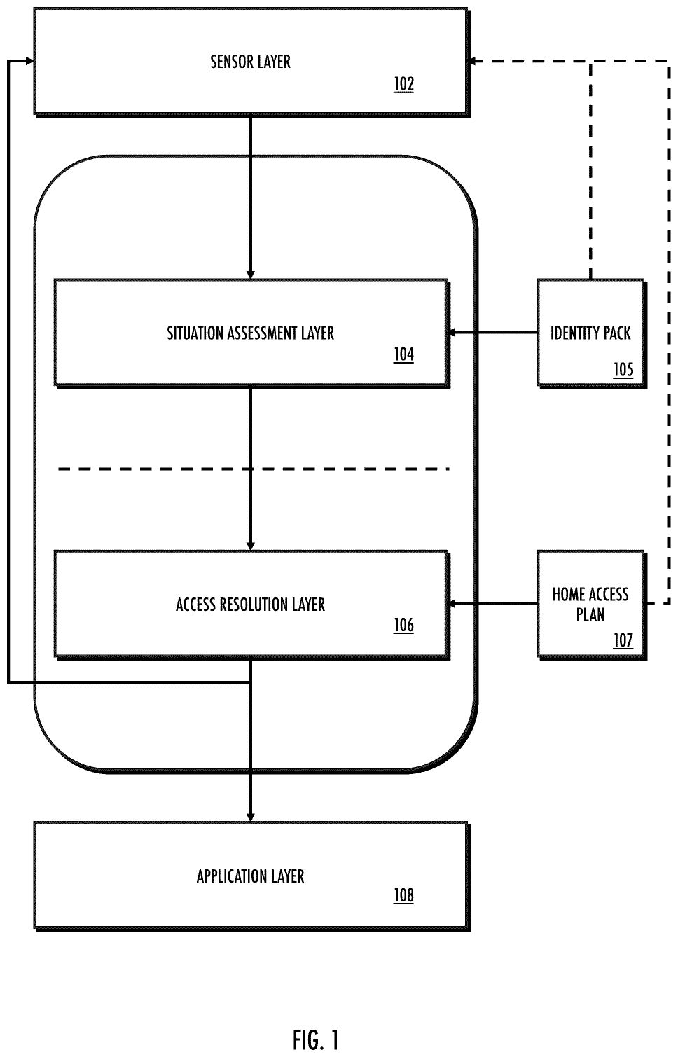

A first aspect of the present disclosure subdivides the physical access resolution system into multiple layers. For example, FIG. 1 depicts a physical access resolution system that includes e.g., a sensor layer 102, a situation assessment layer 104, an access resolution layer 106, and an application layer 108.

Each layer “abstracts” its data and operation from other layers—only the overarching functionality of the layer is presented to other layers (e.g., via an application programming interface (API), etc.). The layered architecture enables interoperation between multiple different subsystems—for example, the situation assessment layer 104 may access multiple different sensors from the sensor layer 102. Similarly, an access resolution layer 106 may generate resolutions that are used by different applications via the application layer 108. As discussed in greater detail below, the layered architecture allows the system to flexibly incorporate components (including 3^{rd} party solutions) to address a wide variety of needs. Additionally, the layered architecture allows for task scheduling of multiple concurrent distinct tasks—this may be particularly useful where e.g., multiple different resolutions are needed to address a situation, etc.

More generally, abstraction may be used to coordinate the functional components of physical access resolution with 3^{rd} party/after-market components and/or other desirable high-level functionality (e.g., cross-physical access resolution scenarios (cross-PAR), etc.). An API-based interface may allow the sensor layer to incorporate a broad selection of sensor technologies; 3^{rd} party sensors may include legacy sensors as well as future sensor technologies. Similarly, an API-based application layer may enable e.g., home automation software, provide remote access, allow cross-PAR communication, and/or enable other modern networked and machine-based applications.

During operation, the physical access resolution system of FIG. 1 uses multi-modal sensing to monitor and detect for approaching subjects (animal, person, machine, etc.) at an access point (e.g., a doorway or other entry point). As the subject approaches, the system will actively use a sensor layer 102 (e.g., an array of sensors having multiple different modalities) to detect and assess the situation, prior to an access attempt (pre-access). In some variants, the sensor layer 102 may also passively capture unique identifiers used by the system. These data structures may be defined by an administrator in identity pack data structures 105 and/or home access plan data structures 107, discussed in greater detail below.

The sensor layer 102 provides its sensed data to the situation assessment layer 104, this layer processes the sensed data and predicts the identity of the subject(s) using the identity pack data structures 105. In one specific implementation, each identity pack data structure is specific to a single registered user. Here, the subject may be identified as a “known” person (a registered user), an “unknown” person (an unregistered user), or “other” entity (e.g., an animal, machine, etc.).

The situation assessment layer 104 may use a confidence-based (non-binary) situation assessment. As used herein, a “session” refers to one or more “challenges” (a sense-assess-resolve path). Instead of a binary decision, each challenge accumulates more confidence-the accumulated confidence is used to trigger resolutions at the access resolution layer 106. The access resolution layer 106 will take the output of the situation assessment layer 104 and adopt one or more resolutions based on the pre-defined home access plan. Resolutions might grant access, deny access, issue additional authentication challenges, etc. Here, “access” refers to both ingress (entry) and egress (exit) situations.

Confidence-based assessment allows the system to assess a much wider range of potential scenarios. For example, the default access challenge path might be based on computer-vision facial recognition and voice-biometrics with a secret word. If the access subject speaks the right secret word, and matches the pre-registered faceprint and voiceprint, the system may grant access to the user. Additional challenges may be used where the faceprint and/or voiceprint are non-determinative; e.g., a timely generated secret word may be transmitted to the user's phone for the user to speak.

During assessment, a first level of confidence may trigger a first resolution (log access attempt), a second level of confidence may trigger a second resolution (grant access), a third level of confidence may trigger a third resolution (request additional authentication), a fourth level of confidence may trigger a fourth resolution (transition to quiescent state), a fifth level of confidence may trigger a fifth resolution (continue to monitor post-access activity). Thus, a very confident assessment may grant access and quiesce, whereas a less confident assessment may grant access but continue to monitor post-access activity. In other words, multiple sources of soft information are used to generate decisions.

Importantly, a session may include multiple concurrent and/or sequential challenges-not just a single sense-assess-resolve path. For example, a first path might include image analysis, a second path might include voice analysis, a third path might be a secret word “loop” that iterates on a previously non-determinative challenge, etc.

The system may support multiple different challenge paths; in fact, there may be alternative resolutions for special challenge paths that have been defined by the administrator. For example, a “neighborhood safe home” might configure the system to allow any child from the neighborhood into the house (even if they do not know the secret word) so long as the homeowner is present. As another example, a caretaker of a patient with dementia or other cognitive impairment may not allow the patient to leave, even if they correctly use their passcode. A person may have a “duress code” which allows them to gain entry but also trigger a silent alarm for help. Still other applications may include in-house delivery—e.g., a package delivery may be allowed entry to securely deliver packages inside the house but trigger immediate security response for unpermitted actions.

Once resolved, the application layer 108 may expose certain information to 3^{rd} party applications to e.g., monitor, record, and/or otherwise interact with the physical access resolution system data. Importantly, the application layer 108 provides a layer of abstraction from other systems; thus, external parties do not have direct access to raw data (which is likely sensitive).

As previously alluded to, abstraction exposes an external data interface, but hides the underlying implementation of data processing. Abstraction allows software to “black box” functionality, which is important for modularity, reliability, and security. In contrast, integration tightly couples data and processing between entities—integration often allows privileged access into the data path and control path operations. In some cases, integration may leverage specialized hardware-based data sharing mechanisms (e.g., semaphore-based read-write protections, etc.) and/or hardware-based acceleration. Integration often can be used to optimize performance and/or minimize reliance on peripheral and/or network resources. Conceptually, abstraction and/or integration are two different design principles that may be used to trade-off benefits.

While the foregoing architecture is described with abstraction layers, certain implementations may benefit from integration. For example, integration may be used to ensure that the situation assessment layer and/or access resolution layer can transfer context for looping processing. Integration may also be useful for localized device processing. In other words, the physical access resolution system can operate without any network access or external device dependencies. This can increase detection accuracy and reduce latency (e.g., faster interventions, etc.). More directly, unlike conventional systems that generally require significant information technology (IT) infrastructure to provide the same functionality, integration may enable a discrete single point solution for both prevention and intervention.

Artisans of ordinary skill in the related arts will readily appreciate that the foregoing system architecture is purely illustrative, and that other implementations may combine, subdivide, add, remove, or otherwise modify the functionalities described above into any layered implementation with equal success.

### 2.2 Privacy-Protections and Staged Sensing

In a completely separate but equally important aspect, the physical access resolution system may implement a multi-staged pipeline to subdivide tasks for privacy and resource utilization. Subdivision of the access event into multiple different stages activates more powerful (and costly) components as-needed, and dynamically de-activates unused components to conserve/free-up resources. In one specific implementation, the physical access resolution system increases data collection only when a subject approaches the access point. This prevents the system from collecting sensitive data of people “passing-by” (they are not approaching and have no intention to access the house).

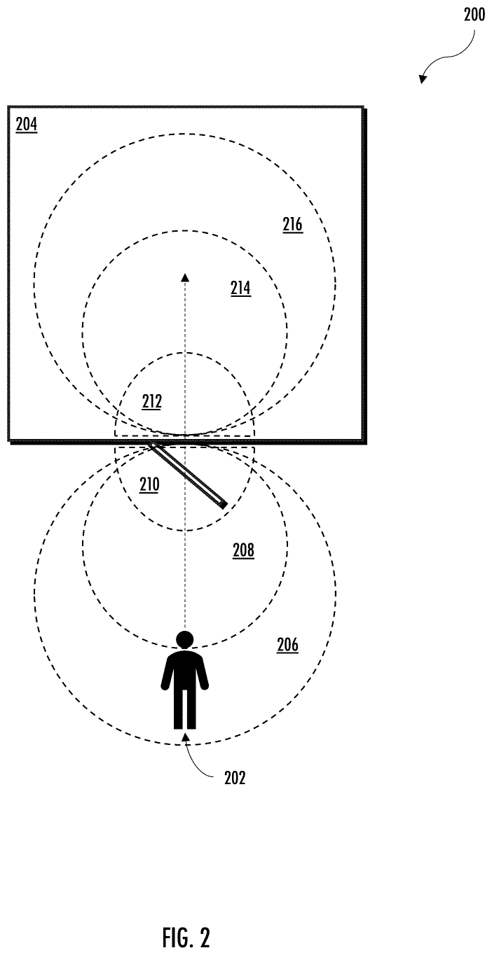

As shown in FIG. 2, one embodiment of the physical access resolution system 200 includes a multi-staged pipeline with different proximity zones. While the following discussion is presented in the context of an ingress scenario, the multi-stage pipeline may be broadly extended to egress scenarios as well. For example, ingress may use zone 206 to wake from idle, zone 208 to capture pre-access activity, and/or zone 210 for access resolution; egress scenarios may use zone 216 to wake from idle, zone 214 to capture pre-access activity, and/or zone 212 for access resolution.

During the first stage of operation, the system is idle until activity is detected. In this example, a passive infrared (PIR) motion sensor senses changes in temperature at a specified distance (zone 206 e.g., 10 meters). the PIR motion sensor only collects thermal changes. When a subject 202 approaches the house 204, thermal activity within zone 206 triggers an ultrasonic time-of-flight (ToF) sensor to detect object motion and accurately track the distance of the object. If the object continues to approach the house and breaks the next defined threshold (zone 208 e.g., 7 meters), a second stage of processing (“pre-access”) is triggered. Notably, neither the PIR motion sensor nor the ultrasonic ToF sensor collect any personally identifying information (they capture “non-personally identifying information”).

The second stage of processing captures pre-access activity. Here, RF sensors, 2D image sensors, and microphones are activated to start capturing uniqueness identifiers within zone 208. A first level of personally identifiable information is collected and used to prepare for an imminent access attempt. Depending on configuration, this preliminary information may be discarded if unused, discarded after review, discarded after a period of time, etc. Once the subject 202 approaches the doorway (zone 210, within 3 meters) the third stage of processing (“access”) is triggered.

In zone 210, the third stage of processing performs access resolution (e.g., the “access granting zone”). Here the system captures access activity and collects a second (higher) level of personally identifiable information that is used to authenticate and/or resolve the access attempt (discussed in greater detail below). For example, 3D depth sensors are activated, and facial recognition may be performed. Depending on configuration, the session and its constituent challenges (sense-assess-resolve paths) may be logged; personally identifiable information may be recorded for long term archival.

Privacy is an important consideration; thus, some variants may provide indications and/or notifications of pipeline progress. For example, there may be status indicator lights (audible chimes, etc.) to explicitly inform the approaching subject that different stages of the pipeline are being activated and/or that personally identifying information is being collected. This gives the approaching subject explicit feedback and the option to de-escalate the pipeline by stopping the approach and/or backing away.

As a brief aside, undesirable activity may be perpetrated by both external and internal bad actors; this is broadly applicable to both residential and commercial applications. Having information leading-up-to, during, and following-after the access event (pre-access, access, and post-access) can provide a complete picture for post-mortem incident analysis. While most physical access control systems are focused on prevention (denying access), the exemplary physical access resolution system may also implement intervention countermeasures—i.e., where access has been granted, but a breach in security or access policy happens, and appropriate action needs to be taken to rectify the situation. Examples might include “tailgating” of an unauthorized actor, propping doors and/or interfering with sensors to prevent normal operation, suspicious activity by authorized persons, etc.

In one exemplary embodiment, a fourth stage of processing may continue to capture post-access activity and/or trigger additional resolutions within zone 212 (or even further into the house, if necessary). For example, the cameras that monitor zone 210 and zone 212 may be implemented as high resolution imagers, each with 180° field-of-view (FOV), that can be stitched together to provide a 360° capture of the post-access activity. An integrated solution may stitch and map the images and/or video from both sensors together with door state and orientation data to create an access event data structure. Completely integrated implementations may provide this functionality entirely on-device using the local resources (such that no external network connectivity is required).

The access event data structure may be rendered in a variety of different ways. For example, the access event data structure may be viewed as an image or video, with seamless re-framing from various different perspectives. One visualization might be an “interior threshold view” that uses a consistent orientation lock of the stitched 360° capture to capture video of the subject(s) as they cross the threshold from zone 210 into zone 212. Other implementations may incorporate other sensors and/or processing to provide different visualizations. For example, computer-vision processing with 3D image sensors can create a depth cloud that may be used, in combination with the door's positioning and known location, to re-map the 3D space into a 2D image from any perspective; e.g., a top-down view might be used to provide a “blueprint view” of the access, etc.

During the fourth stage of processing, post-access activity can be monitored and post-access resolution processing may occur in real-time to trigger interventions if necessary. For example, a post-activity access resolution that permits entry one person at a time can be enforced with audible alarms for attempted tailgating. If the tailgater does not comply, then the remedial actions can be taken (e.g., homeowner notified, emergency services called, etc.). Similarly, a post-access resolution may require that the door shuts within a certain amount of time after access is granted; propping the doors open may trigger audible alarms of escalating intensity, etc. A parcel delivery person may be allowed to deliver packages within the house threshold, but may not have permission to proceed further; post-activity resolution processing may alert the homeowner if the delivery person breaches zone 212, etc. In some variants, the user may get a real-time alert of a delivery and watch the delivery (as a live video stream, animated GIF, etc.)—the user may choose to trigger an intervention resolution if necessary and/or directly communicate with the delivery person.

Importantly, the multi-staged pipeline organizes the access event into multiple phases of activity. Full visibility and context is important for a post-mortem incident analysis of any access attempt (e.g., approach, credentialling, grant, ingress/egress, resecuring the door, and departure), but may also be particularly informative when used to analyze behaviors in aggregate. Categorizations might include patterns of e.g. pre-access activity (approaches, back-offs, etc.), access activity (repeated failures, brute force attempts, etc.), post-access, etc. In some cases, categorization may additionally be based on subject, time-of-day, seasonality, etc. These categories may be reviewed and used to ignore normal routines and/or flag abnormal behavior. For example, pre-access activity reports might identify a subject that repeatedly approaches the house while the homeowner is away. On review, the homeowner can use categorization to quickly filter out innocuous routines (e.g., mailman, helpful neighbors) from more suspicious activity (e.g., a would-be-thief testing to see if the door is consistently locked, etc.).

### 2.3 Multi-Modal Access Processing

As previously alluded to, various aspects of the present disclosure perform “multi-modal” analysis which is a wholly distinct and novel aspect as well. Here, “multi-modal” and its linguistic derivatives refer to analysis that combine multiple different modes of analysis such that no single mode is determinative. As previously mentioned, the multi-modal analysis uses a confidence-based approach to situation assessment and/or access resolution.

Referring back to FIG. 2, the multi-modal analysis accumulates information as the access attempt continues to escalate. For example, the pre-access activity may be used to identify the number of subjects, classify the type of subjects, determine their speed and/or velocity (direction and magnitude), and/or other data collection and processing tasks in preparation of access attempts. This information may be captured from the captured data from RF sensors, image sensors, and microphones within zone 208. In some variants, this may also include information captured from the interior of the house; for example, the system may determine whether there are any occupants already inside the house and/or whether they appear aware (e.g., is someone coming to answer the door, etc.).

The pre-access assessment may trigger different access processing, based on the pre-access situation assessment. For example, a subject that takes a direct path to the front door may be viewed differently than a subject that appears to approach the windows (and/or look inside). Similarly, the types of resolutions that are available may be different based on whether the homeowner is home or not (e.g., authentication may not be necessary if the homeowner can answer the door, etc.). Furthermore, certain types of pre-access information may be used to inform access processing—for example, identity information (identity packs) may be retrieved in preparation of an anticipated visitor, etc.

In the scenario of FIG. 2, the physical access resolution system determines that the subject 202 appears to be a person that is attempting to enter the house 204, and that authentication is the likely next step. As previously mentioned, the assessment layer retrieves a set of identity packs to perform multi-modal subject identification for assessment of the access attempt. In one specific implementation, the “identity pack” data structure associates recognized identities with their corresponding identification characteristics. The physical access resolution system may have a repository of identity packs, which may include both persistent identity packs for its registered users, as well as temporary identity packs to accommodate one-time and/or temporary users.

In one specific implementation, the unique identifiers for each registered user may include a combination of attributes such as (but not limited to): RF signals and unique device ID (BLE, Wi-Fi, UWB) of devices the subject commonly carries, 2D/3D image prints of biometric identifiers (e.g., a faceprint of the subject's face, a gait print of the subject's gait, etc.), uniquely generated machine readable code (QR codes, text, etc.), voice prints, secret access codes, as well as other behavioral trend data (such as daily routines, arrival, and departure times, etc.). Other examples might include e.g., fingerprint/retinal print or other biometric data, PIN code, etc. In some cases, the identity pack may also include information for protocol exchanges with a registered user; here, the user carries an authenticated device (e.g., a digital key or application) that can be reached at a secret network address—the protocol exchange verifies that the user has access to the secret network address; in some cases, this may also include unique device signatures (e.g., RF, etc.).

Identity packs may be cached (pre-loaded) for frequent users but may also be requested/retrieved for a wide variety of other users (e.g., friends, extended relatives, domestic workers, renters, short-term visitors, and/or other entities). In some cases, the identity packs may be encrypted and/or otherwise protected from access-these protections may be particularly important for privacy reasons (e.g., identity packs may include sensitive data that is restricted, even from the system's administrator).

In one specific implementation, the multi-modal subject identification process may select one or more identification modalities from e.g., face recognition, voice analysis, biometric data, PIN codes, keypads, device identification (e.g., smart phone, smart watch, smart glasses, etc.) and/or other identification techniques. Rather than relying on a single identification modality, the different modalities are blended together in a confidence metric. The confidence metric may be compared to a confidence threshold to determine identity.

Different modalities of identifications may have different limitations as well as different levels of performance (e.g., accuracy, precision, complexity, etc.). For example, accuracy may be strongly affected by environmental factors. Facial recognition may perform well in daylight but may do very poorly in low-light conditions. Voice recognition may perform well under quiet conditions, but ambient noise may significantly affect accuracy. Biometric measurements (e.g., fingerprint scans, retinal scans, etc.) may be inconvenient if a person is e.g., holding groceries, wearing gloves, etc. Device-based identification relies on the user having the device on their person.

In one embodiment, the confidence metric may weight the different modalities according to their limitations and/or performance considerations. For example, light levels may be used to adjust the weight of facial recognition. Similarly, voice analysis may be dynamically weighted based on ambient noise. Combining multiple different modalities may provide flexibility and improve accuracy over a wide range of conditions. Importantly, however, there may be a minimum requirement of the number and/or quality of identification modalities. In other words, while it is appreciated that combining modalities may allow the strengths of one modality to compensate for the weaknesses of another (e.g., facial recognition may compensate for voice analysis or vice versa), the combined identification must still provide an acceptable confidence of identity.

Weighting may be based on previously assessed accuracy and/or precision of an identification modality under relevant conditions. As used herein, “accuracy” refers to a numeric assessment of how close a measured value is to the true value. “Precision” refers to the degree of repeatability, consistency, or reproducibility in a set of measurements. Precision and accuracy are different metrics for measuring error, thus a precise measurement may not be accurate and vice versa. Furthermore, as a practical matter, reducing false positive rates may also increase the rejection of true positives, etc.—thus, perfect accuracy and/or precision may not always be desirable.

A variety of different statistical techniques can be used to generate a confidence metric based on weighting and probability. For example, Bayesian inference may be used to assess probabilities based on a series of observations. Bayes' theorem calculates a posterior probability of a parameter given an observed data, a prior probability of the parameter, and a likelihood of the observed data given the parameter. In a multi-modal identification scheme, Bayesian inference may be extended to calculate the likelihood of a true positive/negative from the false positive rates/false negative rates of the combined modalities and their actual observed positive/negatives.

As used herein, true positives (TP) represent the number of correctly predicted positive instances, false positives (FP) represent the number of incorrectly predicted positive instances, true negatives (TN) represent the number of correctly predicted negative instances, and false negatives (FN) represent the number of incorrectly predicted negative instances. Thus, for example, the false positive rate (the likelihood that a positive is incorrect) is the number of false positives divided by the total number of positives.

While the foregoing examples are presented in the context of statistical analysis, artificial intelligence and machine learning may also be used with equal success. For example, a neural network may be trained to identify a user during an offline training process. Then during online operation, the neural network may calculate a confidence metric based on its training. In some cases, the training library may accumulate a history of user identifications over time, to further improve identifications.

More generally, any confidence-based heuristic may be substituted with equal success. As used herein, the term “confidence” and its linguistic derivatives refers to a measure of certainty or uncertainty about a decision. Here, a decision may be a binary value (“1”, “0”), whereas the confidence metric may be a quantity/quality within a range. A confidence metric could be a statistical measurement (standard deviation, median, etc.) or probability (0-100%). Artificial intelligence and/or machine learning models frequently use non-linear activation functions (e.g., ReLU, ELU, SELU, tanh, etc.)—thus, some confidence metrics may use activation values or some derivative thereof. Still other systems may use enumerated values (e.g., “very confident”, “mostly confident”, “not confident”, “ambiguous”, etc.).

In one specific implementation, thresholds may be user selected to balance security with convenience; e.g., a user may prefer a more secure authentication or a more convenient authentication process, etc. In some cases, the user may also configure retry protocols. For example, a failed attempt may allow the user to attempt again or may require the user to use a more secure authentication method for a retry (e.g., PIN code, two-factor authentication, etc.).

In addition to determining identity, the assessment layer may also consider the time and manner of access. For example, the assessment layer may determine whether the access fits a pattern of use or is otherwise expected. Patterns of use may be learned over time, and used to anticipate certain likely events (e.g., coming home from work or school, etc.). In addition, the physical access resolution system may also have access to external information. Calendaring services and/or notifications may be used to predict accesses. For example, a user's personal calendar software may be used to estimate e.g., scheduled arrivals, departures, vacations, etc. Location sharing may be used to receive and/or retrieve a real-time (or near real-time) location of the user. In fact, 3^{rd} party notifications may even be used to anticipate expected arrivals of guests, domestic workers (house maids, contractors, real estate agents, etc.), delivery persons, etc.

Once the subject has successfully authenticated (e.g., the confidence of their multi-modal authentication exceeds the threshold), the physical access resolution system performs access resolution to determine the appropriate resolution(s). More directly, successful authentication to an identity pack enables the authorizations associated to the identity pack. The authorizations are mapped to a “home access plan” data structure.

In one specific implementation, the “home access plan” data structure associates authorization types to resolution types. For example, authorizations may be e.g., unrestricted/privileged, restricted/privileged by time, restricted/privileged by location or zone, restricted/privileged by number, and/or any other restriction/privilege. Resolution types may include e.g., grant/deny ingress, grant/deny egress, conditional grant/deny ingress, conditional grant/deny egress, notify administrator, notify 3^{rd} party, notify emergency services (alarm, silent alarm), log ingress/egress, monitor interior/exterior, and/or any other action-based operation. Additionally, resolution types may be timed to specific stages: for example, resolutions may take effect during pre-access, access, and/or post-access.

Here, restrictions refer to a limitation that is selectively imposed on certain users, whereas privileges refer to a power that is selectively granted to certain users. For example, the homeowner may have unrestricted access to enter and/or leave the house; in addition, they may have selectively granted privileges such as anonymous access (e.g., untracked entry/exit) and/or room control (temperature, lighting, music, etc.) which other users do not have. Other co-tenants may have fewer privileges and/or more restrictions. For example, a child or a relative with dementia may not be tracked and may have unrestricted ingress (entry), but restrictions on egress (exit) and/or the number of guests they may bring may be imposed. Other visitors (e.g., guests, domestic workers, delivery persons, and/or other guests) may not have any special privileges and/or may be restricted for specific activities—e.g., a domestic worker's entry/exit may be logged, tailgaters may not be permitted, and their activity may be recorded. As another example, a delivery person may be allowed in the interior threshold for secure package delivery but trip an alarm if they proceed further.

### 2.4 Other Notable Variants and Improvements

Conceptually, the richness of residential access scenarios may be difficult to set-up. While corporate physical access control systems are handled by system administrators that are well-versed in the arts, it is unlikely that most consumers would have equivalent expertise. A large majority of scenarios may be handled with default settings and data structures; however, it is appreciated that most consumers are likely to need adjustments to suit their specific needs. Thus, various embodiments of the present disclosure may use an administrator application to create and/or modify identity packs and home access plan data structures as-needed. While the following example is presented in the context of a “messaging” type user interface, other interfaces may be substituted with equal success.

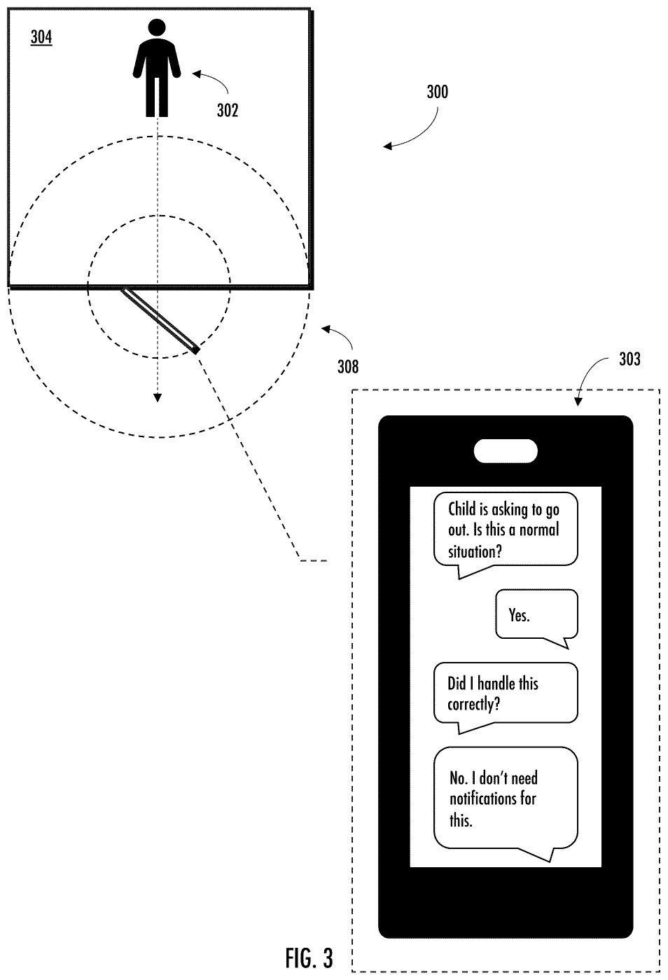

FIG. 3 presents an exemplary egress (exit) scenario 300. In this example, the subject 302 is a child that is at the house 304; the homeowner is not at home but has an administrator application 303 on their phone that provides notifications and/or remote control of the system. The physical access resolution system has locally cached the identity packs and home access plan data structures for the current occupants.

In this simple example, the interior of the house does not use a motion sensor, instead a low-power camera periodically captures the interior threshold area 308 to monitor for activity during a first stage of processing (pre-access situational assessment). The low-power camera may include computer-vision logic that is trained to recognize actions that suggest an imminent egress.

In this case, the subject 302 approaches the interior threshold area 308 of the house 304 and begins putting on their shoes and preparing to leave. Responsively, the situation assessment layer of the physical access resolution system retrieves its locally cached set of identity packs for the current occupants. In some cases, the physical access resolution system may also launch pre-access resolutions that notify the administrator of an event that may need attention (e.g., the homeowner may have set a vibration alert for any co-tenant preparing to leave, regardless of identity).

Here, the subject 302 is authenticated using the aforementioned locally cached identity packs and confidence-based metrics. The physical access resolution system is able to confidently identify that the subject 302 is the child based on a facial recognition scan, voice analysis, its current listing of occupants, etc. However, as previously alluded to, situational assessment is more than just identification-the user's intended action may also be important for situation assessment. In this case, the identified child is a minor and their identity pack does not specify whether they are permitted to leave.

As shown in FIG. 3, the administrator application 303 notifies the administrator of the identified situation (“Child is asking to go out”), and additionally asks the administrator whether this situation should be recognized for future operation (“Is this a normal situation?”). The administrator's response (“Yes”) confirms to the administrator application 303 that the situation assessment layer may update the identity pack for the subject 302 to recognize this situation.

Furthermore, the administrator application 303 clarifies whether the default resolution (notify administrator to grant egress) for minors applies to subject 302. Specifically, the administrator application 303 asks “Did I handle this correctly?”, here the administrator may confirm or provides clarification otherwise (“No. I don't need notifications for this” may set the subject 302′s resolution to unrestricted “grant egress”).

While the foregoing example has a homeowner that administrates the system, it is recognized that these two user types are distinct; e.g., a caretaker may be the administrator for an elderly homeowner, etc.

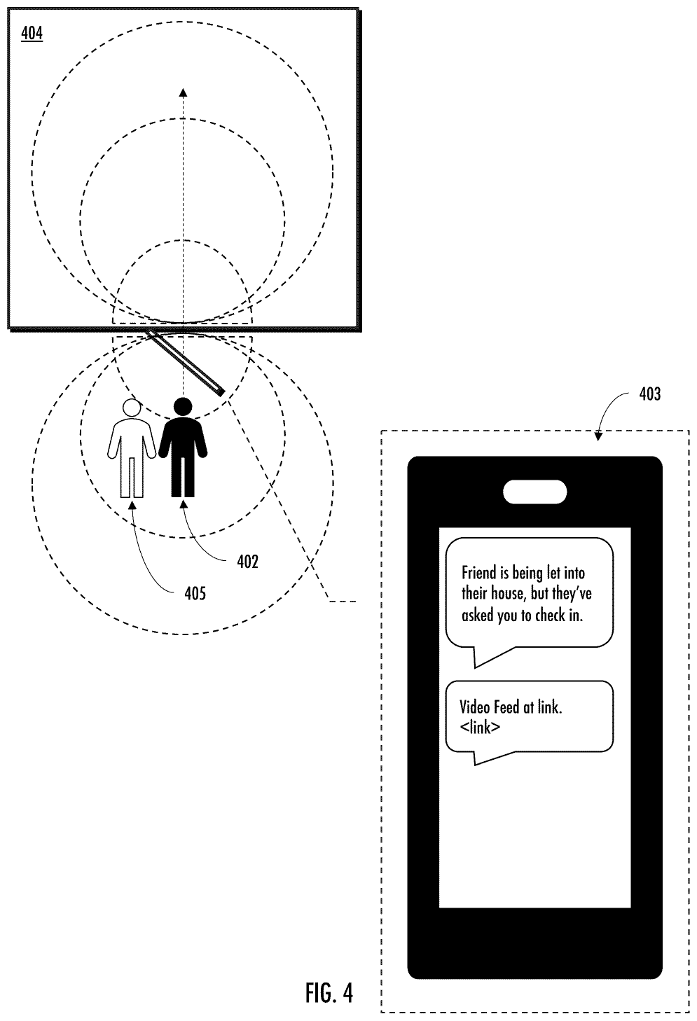

FIG. 4 presents an exemplary “duress code” scenario. Duress scenarios occur when a person authenticates themselves and one or more malicious actors. While the most commonly imagined (and least likely) duress scenario occurs with the threat of physical violence, duress often can occur under many less threatening situations. As but one such example, an inebriated person may be talked into letting an unfamiliar acquaintance inside the house. Children and the elderly may also let a “visitor” in, without realizing their mistake until it is too late.

In this example, a subject 402 and an unknown person 405 approach the home 404. Perhaps the subject 402 does not want to seem rude to the unknown person 405 and decides to use a “duress” code to explicitly notify the system of the situation. In other cases, the subject 402 may not be in a mental state to enter the house unassisted—the system may determine this through image and/or voice analysis (e.g., slurred speech, etc.). Either way, in this case, the physical access system may resolve to allow the subject 402 and the unknown person 405 inside, but also to continue to monitor the situation.

In some implementations, the physical access system may message a trusted contact and provide a video feed of the interior of the house. The trusted contact may review the footage and determine appropriate action (e.g., whether to intervene or not). In other implementations, the physical access system may alert emergency personnel. Some variants may use a silent alarm such that the unknown person 405 does not attempt to flee. Other variants may explicitly alert the subject 402 and the unknown person 405 that help is on the way.

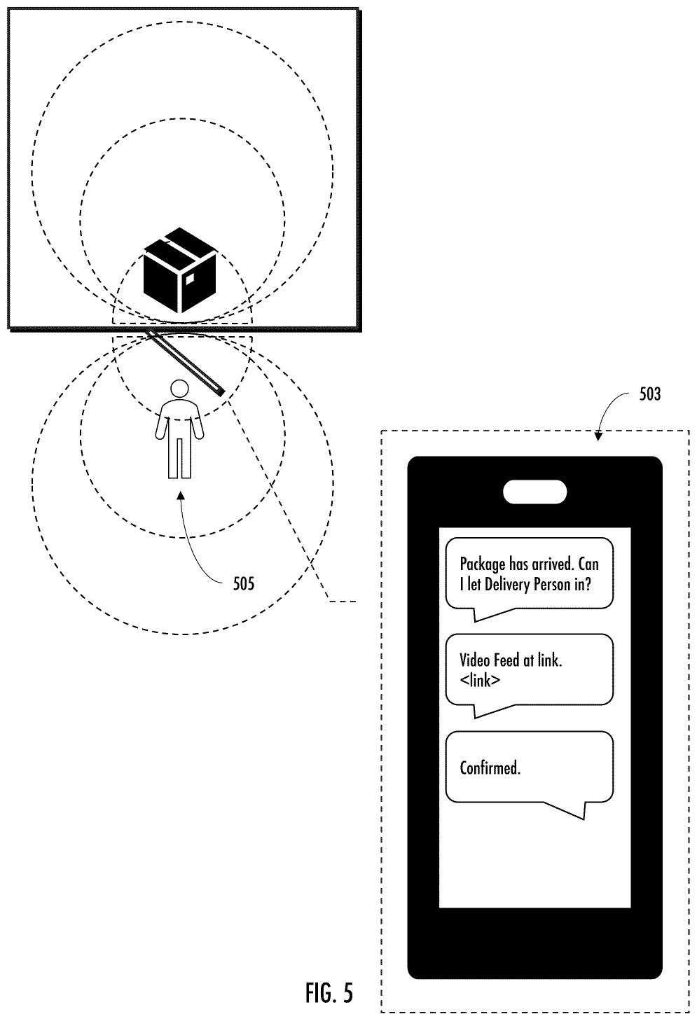

FIG. 5 presents an exemplary interior parcel drop-off scenario. Porch theft has become a significant problem for parcel delivery companies. Ideally, direct delivery into the home would be preferred, yet there remain significant privacy issues for both the homeowner, delivery people, and the parcel delivery companies.

In the illustrated scenario, the homeowner may be notified of the parcel delivery person 505 via a messaging application 503. Depending on configuration, the homeowner may verify parcel delivery either in real-time or after the fact. The access resolution may be to grant ingress within the threshold area, but no further. In some cases, the parcel delivery person may be explicitly notified that they are being monitored but that if delivery conditions are followed, the recording will be destroyed. Additionally, the post-access resolution may store the parcel delivery person's biometric data for law enforcement-based incident analysis but secure the biometric data from the homeowner administrator. In this way, the homeowner (and parcel delivery service) may be reasonably assured of security and safeguard privacy for legitimate activity, while also preserving important identifying information for law enforcement.

### 3 System Architecture

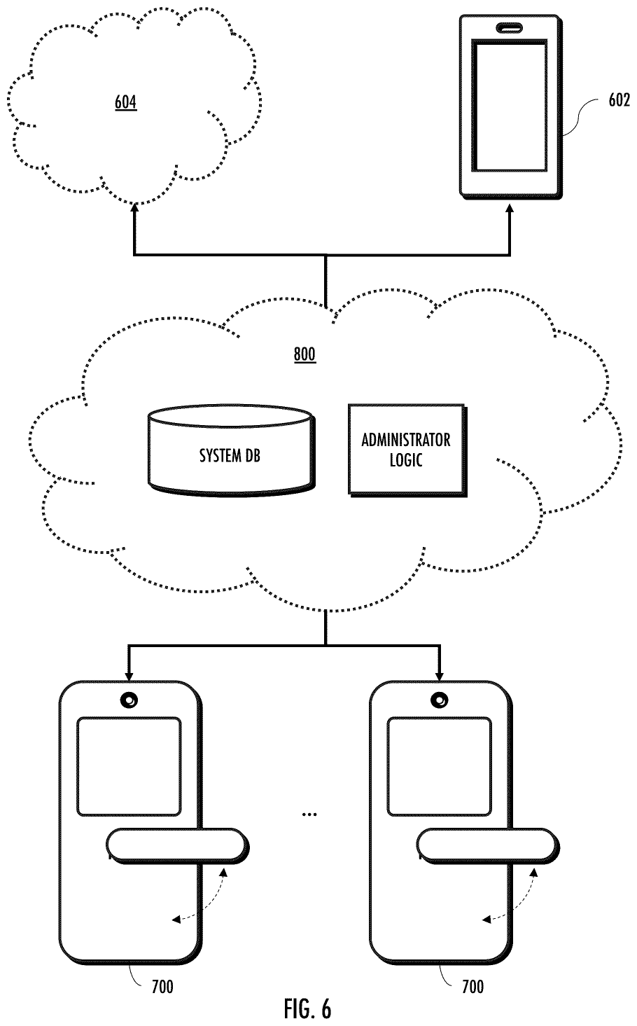

Various aspects of the present disclosure are now discussed with reference to a logical block diagram of one system for access resolution based on situational awareness depicted within FIG. 6, useful in accordance with various aspects of the present disclosure. The system of FIG. 6 includes: physical access resolution devices 700 and system administration logic 800. In some variants, the system administration logic 800 may additionally interact with user devices 602 and/or external applications via the public internet 604.

The following examples are discussed in the context of physical access resolution devices 700 that manage physical access control of a physical threshold, and system administration logic 800 that coordinates operation of the physical access resolution devices 700 to evaluate situations and/or propagate situational information (situational awareness). More generally, however, artisans of ordinary skill in the related arts will readily appreciate that the functionalities described herein may be combined, divided, hybridized, and/or augmented within different entities. For example, a physical access resolution device may directly evaluate situational awareness locally and/or broadcast information to other devices (including other physical access resolution devices). Similarly, a system administration logic 800 may be managed with a user device and/or other cloud infrastructure.

### 3.1 Physical Access Resolution Based on Situational Awareness

Physical access resolution devices refer to devices that manage physical access control of a physical threshold. Physical access control is subdivided into situation assessment (situational awareness) and access resolution (e.g., pre-access, access, and post-access action). Notably, physical access resolution may include additional activity beyond permitting and/or denying access—e.g., monitoring may continue to ensure that entrants comply with permitted behaviors, etc.

As a practical matter, physical access resolution devices may have a broad range of capability. For example, some physical access resolution devices may capture localized information (one or more of acoustic, visual, and/or electromagnetic information from the environment in addition to user inputs) to assess an access event (situational awareness). More sophisticated implementations may additionally incorporate information from other entities of the system (e.g., other physical access resolution devices, system administrator, and/or user devices). Complex implementations may also interact with 3^{rd} parties beyond the system to e.g., obtain assistance, emergency services, etc. More broadly, any device that resolves physical access based on situational assessment may provide “physical access resolution” functionality.

Physical access resolution devices may implement localized control over its own functionality. For example, a physical access resolution device may need to operate in isolation (e.g., in the event a malicious actor attempts to disable connectivity, jam communications, etc.). In some variants, the physical access resolution device may additionally localize and/or obfuscate sensitive information (e.g., a user's comings and goings, etc.). In some variants, certain user permissions may enable the ability to provide default access settings and/or manually override localized control.

While the following discussions are primarily discussed in the context of event-driven access (e.g., a person approaching a door), physical access resolution devices may also receive and/or service access events from other entities (e.g., remote access requests). For example, a user may remotely open a door for their pet, child, etc. In some cases, the physical access resolution device may assess the remote user's environment (in addition to its local environment) for such accesses; other forms of access control may also be used (e.g., rule-based, etc.).

“Physical access control” refers to security techniques for managing entry to physical spaces such as buildings, rooms, and facilities. This can include security measures like keycards, biometric scanners, turnstiles, as well as security guards, surveillance cameras, etc. In many cases, these mechanisms are designed to authorize and authenticate individuals, devices, or entities before granting them entry or permission to the physical space.

An “access event” is characterized by a person (or other entity e.g., drone, animal, etc.) attempting access to a physical space (zone) via a physical threshold.

A “physical threshold” refers to a transitional partition to control ingress/egress between two or more spaces. Examples of physical thresholds may include e.g., door, window, gate, bridge, turnstile, checkpoint, etc. Physical thresholds may have a position, displacement, velocity, and/or acceleration along a pathway (threshold pathway). The position, displacement, velocity, and/or acceleration may be sensed along with other parameters to e.g., infer a current state of the physical threshold (e.g., open, closed, locked, unlocked, etc.).

A “zone” or “space” may be further categorized according to its use. For example, interior zones may refer to areas enclosed by the building features (walls, windows, ledges, etc.), exterior zones may refer to areas that are not enclosed by the building features. So-called “security zones” may refer to zones which are monitored for security reasons, similarly “occupancy zones” may refer to zones which are not monitored or where monitoring is used for occupational needs. In fact, zones may have different categorizations and/or overlapping regions. For example, an exterior security zone may have partial, or even complete, overlap with exterior occupancy zones, etc. A variety of other categorizations may be substituted with equal success. “Occupancy” refers to a monitored number of entities (persons, pets, vehicles, etc.) which are within a zone or space.

As a brief aside, a finite state machine (or “state machine”) refers to a machine that can only be in one of a finite number of “states”. Each state has a limited set of valid inputs, outputs, and/or data manipulations. The state machine “transitions” between states in response to certain inputs. A machine is “stateful” if it can consider preceding events or interactions in its logic (i.e., it remembers at least a current and previous state), stateless logic does not consider preceding events/interactions.

“Events” may broadly encompass any change or occurrence that has significance for operation of a system. For example, access events refer to events that trigger an access resolution. A variety of event categories are discussed throughout e.g., device events (e.g., battery events, network events, etc.), administrative events (e.g., adding a user, sending a multi-factor hybrid key, etc.), access events, delivery events, occupancy events (e.g., changes that affect the occupancy state of a residence”), etc. Still other events may be substituted with equal success, the foregoing being purely illustrative.

Events may be further categorized according to other factors. Schemes may be based on frequency, priority, risk, user-defined categories, etc. For example, a scheme for categorizing access events according to security risk and response might use e.g., routine (log only), anomalous (log, monitor, and notify), and/or urgent (log, monitor, notify, and/or initiate action).

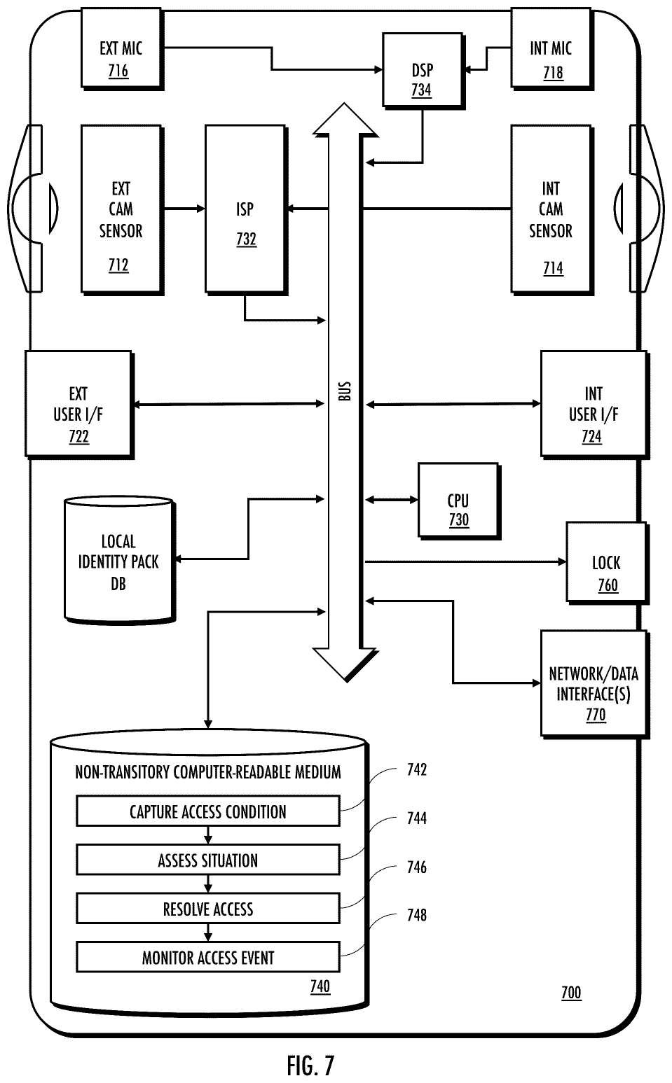

FIG. 7 is a logical block diagram of physical access resolution device 700. The physical access resolution device 700 includes: a sensor subsystem, a user interface subsystem, a data/network interface, a physical actuation subsystem, and a control and data processing logic.

The sensor subsystem captures data from the environment. The user interface subsystem monitors the user for user interactions and renders data for user consumption. The control and data processing logic obtains data generated by the user, other devices, and/or captured from the environment, to perform calculations and/or data manipulations. The resulting data may be stored, rendered to the user, transmitted to another party, or otherwise used by the device to carry out its tasks. The physical actuation subsystem actuates one or more physical mechanisms to enable/disable (lock/unlock) and/or articulate (open/close) a physical threshold to permit access. The data/network interface converts data for transmission to another device via transmission medium. In some cases, the physical access resolution device may incorporate localized power (e.g., battery power) in addition to main power (e.g., power from an outlet or other wired connection).

The various logical subsystems described herein may be combined, divided, hybridized, and/or augmented within various physical components of a device. As but one such example, an interior-facing camera and exterior-facing camera may be implemented as separate, or combined, physical assemblies. As another example, data processing logic may occur in multiple components of the physical access resolution device. More generally, the logical block diagram illustrates the various functional components of the physical access resolution device, which may be physically implemented in a variety of different manners.

Referring first to the sensor subsystem, a “sensor” refers to any electrical and/or mechanical structure that measures, and records, parameters of the physical environment as analog or digital data. The physical access resolution device may incorporate multiple different modalities of sensor data; for example, visual data may be captured as images and/or video, audible data may be captured as audio waveforms (or their frequency representations), electromagnetic radiation may be captured via antennas, biometric data may be captured via touch sensors, etc. The following sections provide detailed descriptions of the individual components of the sensor subsystem.

A camera lens bends (distorts) light to focus on the camera sensor. The camera lens may focus, refract, and/or magnify light. It is made of transparent material such as glass or plastic and has at least one curved surface. When light passes through a camera lens, it is bent or refracted in a specific way, which can alter the direction, size, and/or clarity of the image that is formed. In the illustrated embodiment, the camera lenses are “wide” FOV camera (so-called fisheye lenses provide between 120° and 195°). Other implementations may use normal FOV (between 90° and) 120°, or even narrow FOV (below) 90°, cameras.

A camera sensor senses light (luminance) via photoelectric sensors (e.g., photosites). A color filter array (CFA) filters light of a particular color; the CFA provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Notably, most imaging formats are defined for the human visual spectrum; however, machine vision may use other variants of light. For example, a computer vision camera might operate on direct raw data from the image sensor with a RCCC (Red Clear Clear Clear) color filter array that provides a higher light intensity than the RGB color filter array used in media application cameras.

The camera module(s) may include on-board image signal processing and/or neural network processing. On-board processing may be implemented within the same silicon or on a stacked silicon die (within the same package/module). Processing functionality is discussed further below.

During operation, the physical access resolution device may make use of multiple cameras to assess user interactions and the physical environment. For example, a first camera 712 may capture visual information from an exterior space associated with a physical threshold and a second camera 714 may capture visual information from an interior space associated with the physical threshold.

While the foregoing techniques are described in the context of perceptible light, the techniques may be applied to other electromagnetic (EM) radiation capture and focus apparatus including without limitation: infrared, ultraviolet, and/or X-ray, etc. As but one such example, an IR (infrared) sensor works by detecting infrared radiation (heat). IR sensors are commonly used to detect presence, motion, or temperature. There are two main types of IR sensors: active and passive.

An active IR sensor has two main components: an IR emitter (usually an LED) and an IR receiver (usually a photodiode or phototransistor). The IR emitter sends out a beam of infrared light, and the IR receiver detects any reflected IR and/or change in reflected IR. Based on this change, the system determines presence, proximity, or distance.

A passive IR (PIR) sensor doesn't emit anything. It only detects infrared radiation changes in its environment, usually from warm bodies like humans or animals. Typically, a PIR sensor has two slots made of pyroelectric material, which generate an electrical signal when it detects changes in IR levels. When a warm body moves across the sensor's field of view, it creates a difference between the two slots, and triggers a detection.

Audio sensors (e.g., first microphone 716, second microphone 718) are typically incorporated within an audio module that also includes speakers, and an audio codec/digital signal processor 734. The microphones sense acoustic vibrations and convert the vibrations to an electrical signal (via a transducer, condenser, etc.). The electrical signal is provided to the digital signal processor 734, which samples the electrical signal and converts the time domain waveform to its frequency domain representation. Typically, additional filtering and noise reduction may be performed to compensate for microphone characteristics. The resulting audio waveform may be compressed for delivery via any number of audio data formats. To generate audible sound, the digital signal processor 734 obtains audio data and decodes the data into an electrical signal. The electrical signal can be amplified and used to drive the speaker to generate acoustic waves.

During operation, the physical access resolution device may make use of multiple audio sensors to assess user interactions and the physical environment. For example, a first microphone 716 may capture acoustic information from an exterior space associated with a physical threshold and a second microphone 718 may capture acoustic information from an interior space associated with the physical threshold.

The audio module may include on-board audio processing and/or neural network processing to assist with acoustic analysis and synthesis. Processing functionality is discussed further below.

Cameras and microphones may additionally be used to derive other types of information. For example, a time-of-flight (TOF) sensor is a type of distance measurement sensor that uses light or sound to estimate distance. A light-based TOF sensor may use IR lasers or LED pulses to emit light waves toward a subject, and the reflected waves can be measured for time-of-flight data. The time-of-flight can be used to calculate distance. An acoustic TOF sensor uses the same principles with acoustic waves (e.g., ultrasound, etc.).

Biometric sensors are devices that detect and measure unique physical or behavioral traits to identify and/or verify individuals. Most biometric sensors follow a similar process: a sensor acquires raw biometric data, feature extraction processes it into a feature set (a “template”), and pattern matching compares the features to stored templates. Common examples include fingerprint scanners, facial recognition systems, iris and retina scanners, and voice recognition sensors. A brief discussion of illustrative biometric scanners (fingerprint and retinal) are provided, other biometric scanners may be substituted with equal success.

Fingerprint scanners use optical, capacitive, ultrasonic, or other sensing apparatus to identify a ridge and valley pattern of a fingerprint. Optical variants shine light on the finger and uses a camera to take a high-contrast image of the fingerprint. Capacitive variants use arrays of capacitor electrodes to detect the fingerprint pattern based on differences in capacitance (capacitance above a threshold is a ridge, below the threshold is a valley.) Ultrasonic variants emit ultrasonic waves to image the fingerprint; the ridges and valleys reflect the ultrasonic waves differently-ridges contact the sensor surface and reflect sound back strongly, while valleys (air gaps) reflect weakly or not at all.

A retinal scanner works by capturing the unique pattern of blood vessels in the retina, the thin layer of tissue at the back of the eye. Typically, a low-intensity infrared beam (typically 700-900 nm wavelength) is projected into the eye. Infrared is used because it's safe for the eye and penetrates the retina more effectively. The blood vessels in the retina absorb more infrared light than surrounding tissue, creating a distinct contrast pattern. An IR camera detects the reflected pattern. The scanner may sweep the infrared beam in a spiral or raster pattern to build a high-resolution map of the blood vessel structure. This scan captures features such as branching patterns, width, and positioning of the vessels.

Other components of the physical access resolution device may further augment sensor functionality. For example, the data/network interface 770 may provide electromagnetic sniffing (in addition to its communication functionality). Similarly, the user interface subsystems (first user interface 722, second user interface 724) may be incorporated with biometric scanners, etc.

Referring now to the user interface subsystem, the “user interface” refers to the physical and logical components of the physical access resolution device that interact with a human user. The user interface subsystem may encompass visual, audio, and tactile elements.

Mechanical buttons work by physically closing an electrical circuit when pressed. Typically, a spring-loaded mechanism keeps contacts apart. When pressed, the mechanism compresses and brings the contacts together, allowing current to flow through the circuit. Releasing the button causes the spring to push the contacts apart again, breaking the circuit. There are several types of mechanical buttons. Toggle switches flip between two states, like on/off, using a lever mechanism. Push-button switches are momentary or latching—momentary ones only work while pressed, while latching ones stay in place until pressed again. Rotary switches are turned to select different settings or circuits. Mechanical buttons are cost effective and can be ruggedized, but many modernized devices have moved toward resistive and/or capacitive touchscreen interfaces that “mimic” the functionality of mechanical buttons.

In addition to physical user interface devices that use buttons to register explicit user input, the user interface subsystem may also incorporate various components of the sensor subsystem to sense user interactions. For example, the user interface may include: a display module to present information, biometric sensors to capture biometric indicia, a camera to capture user gestures, a speaker to provide audible information, and a microphone to capture voice commands, etc.

The display module is an output device for presentation of information in a visual form. Common display technologies include LCD (liquid crystal display), LED (light-emitting diode), and OLED (organic LED) screens, each using different technologies to produce images. They can show static text, dynamic graphics, or video, depending on their design and purpose. The choice of display type depends on factors like brightness, resolution, power consumption, and viewing angle.

In many cases, a touchscreen interface may be overlaid to allow users to interact directly with a display by touching it. The most common types are resistive, capacitive, and infrared. Resistive touchscreens use two flexible layers that register touch when pressed together, making them durable and responsive to any touch input, including gloves or styluses. Capacitive touchscreens use the electrical properties of the human body to detect touch and support multi-touch gestures but usually require bare skin or special conductive materials. Infrared touchscreens use a grid of light beams across the screen surface, detecting touch when beams are interrupted.

As previously noted, the user interface subsystem may additionally incorporate cameras and microphones to collect the user's gestures, facial details, vocal instructions as well as the environmental images and sounds. See discussions of sensor subsystem operation elsewhere.

Functionally, the data/network interface subsystem enables communication between devices. For example, the physical access resolution device may communicate with the system administration logic, another physical access resolution device, a user device, etc. In some cases, the physical access resolution device may also need to access remote data and/or 3^{rd} parties (e.g., emergency services, etc.).

The network interface may include both wired interfaces (e.g., Ethernet and USB) and/or wireless interfaces (e.g., cellular, local area network (LAN), personal area network (PAN)) to a communication network. As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). For example, the physical access resolution device may directly connect, or indirectly tether to another device with access to, the Internet. “Tethering” also known as a “mobile hotspot” allows devices to share an internet connection with other devices. For example, a smart phone may use a second network interface to connect to the broader Internet (e.g., 5G/6G cellular); the smart phone may provide a mobile hotspot for the physical access resolution device over a personal area network (PAN) interface (e.g., Bluetooth/Wi-Fi), etc.

Functionally, the physical actuation subsystem 760 actuates, in whole or part, a physical threshold to grant/deny access. A typical mechanical lock subsystem may include a lock body, a latch or bolt, a strike plate, and an actuator. The lock body secures and protects the components of the lock subsystem to prevent malicious tampering and/or environmental fouling. The latch or bolt may be attached to a door (or other physical body) and can be extended into/withdrawn out-of the strike plate of a door frame. When the latch is extended into the strike plate (e.g., “locked”), the door is fixed within the door frame; the latch may be withdrawn to permit the door to be opened (e.g., “unlocked”). Simple electromechanical actuation may be used to actuate the latch, as instructed, by a “smart lock” application or other logic.

More generally, physical actuation may be implemented in any number of ways. Mechanical and/or electro-mechanical actuation (via solenoids, servos, and/or electric motors) etc. refers to actuation of mechanical elements (rigid bodies). Pneumatic actuation refers to actuation via compressed gasses and/or compression-based actuation. Hydraulic actuation refers to actuation via fluid transfer. Fluids are substantially less compressible than gas but are not rigid solids, thus, hydraulic actuation may provide offer design trade-offs. Magnetic and/or electromagnetic actuation are other actuation mechanisms commonly available in the related arts.

While hinged doors are the most common form of physical threshold, there are a large variety of other door styles and/or mechanisms. Examples may include, without limitation, sliding doors (e.g., bypass doors, pocket doors, rolling doors, etc.), folding doors (e.g., accordion doors, bi-fold, tri-fold, etc.), pivot doors, revolving doors, up-and-over doors, rolling/rolling shutter doors, vertical lift doors, Dutch doors, etc.

While the foregoing examples are presented in the context of opening and closing a latch/bolt and striker assembly, physical actuation may be extended to the other portions of the door and/or the whole door. For example, powered doors may be opened and/or closed to grant/deny access. For example, a sliding door may be physically actuated into a fully open, fully closed, or partially open/closed configuration by changing the amount of linear motion. Similarly, a pivot door may be physically actuated into a fully open, fully closed, or partially open/closed configuration by changing the amount of pivot motion. Powered Dutch doors may allow a first portion of the door to be opened (e.g., a window), while the lower portion remains closed.

Different door mechanisms may have different means and/or mechanisms for controlling an aperture size in various gradations; e.g., a powered hinge door may be partially opened to permit a breeze. The gradation may span e.g., fully open, fully closed, partially open/closed (e.g., 25%/75% 50%/50%, 75%/25%, etc.). Powered sliding doors and/or other door mechanisms may have similar mechanisms.

Notably, other apertures (e.g., windows, vents, etc.) may also provide physical access-examples may include e.g., single-hung, double-hung, sliding, casement, awning, hopper, jalousie/louvered, tilt, and/or other window mechanisms. More generally, artisans of ordinary skill in the related arts will readily appreciate that the techniques described within may be broadly extended to actuation, in whole or part, of any aperture mechanism or assembly with equal success.

The control and data subsystem controls the operation of a device and stores and processes data. Logically, the control and data subsystem may be subdivided into a “control path” and a “data path.” The data path is responsible for performing arithmetic and logic operations on data. The data path generally includes registers, arithmetic and logic unit (ALU), and other components that are needed to manipulate data. The data path also includes the memory and input/output (I/O) devices that are used to store and retrieve data. In contrast, the control path controls the flow of instructions and data through the subsystem. The control path usually includes a control unit, that manages a processing state machine (e.g., a program counter which keeps track of the current instruction being executed, instruction register which holds the current instruction being executed, etc.). During operation, the control path generates the signals that manipulate data path operation. The data path performs the necessary operations on the data, and the control path moves on to the next instruction, etc.

The control and data processing logic may include one or more of: a central processing unit (CPU 730), an image signal processor (ISP 732), and digital signal processor (DSP). In some variants, the device may also include one or more neural network processors (NPUs), and their corresponding non-transitory computer-readable media 740 that store program instructions and/or data. In one exemplary embodiment, the control and data subsystem includes processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

Different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: operating system (OS) functionality (power management, UX), memory management, gesture-specific tasks, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks and must account for branch disruption and/or arbitrary memory access.

In contrast, the image signal processor (ISP) and digital signal processor (DSP) perform many of the same tasks repeatedly over a well-defined data structure. For example, the ISP maps captured camera sensor data to a color space. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. DSP operations are also similar in definition, operation, similarity, and specialization. Acoustic waveforms are of known sample size, may include specialized FFT (or derivative) logic, and highly repetitive.

In some cases, the device may include one or more neural network processors (NPUs). Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Other processor subsystem implementations may multiply, combine, further subdivide, augment, and/or subsume the foregoing functionalities within these or other processing elements. For example, multiple ISPs may be used to service multiple camera sensors. Similarly, neural network functionality may be subsumed with either CPU or ISP operation via software emulation.

In one embodiment, the control and data processing subsystem may be used to store data locally at the device. In one exemplary embodiment, data may be stored as non-transitory symbols (e.g., bits read from non-transitory computer-readable mediums). In one specific implementation, a memory subsystem including non-transitory computer-readable medium is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use.

In some embodiments, the program code may be statically stored within the device as firmware. In other embodiments, the program code may be dynamically stored (and changeable) via software updates. In some such variants, software may be subsequently updated by external parties and/or the user, based on various access permissions and procedures.

One specific implementation of the physical access resolution device 700 may include a non-transitory computer-readable medium that includes a routine that performs situation assessment (situational awareness) and access resolution. When executed by the control and data subsystem, the routine causes the physical access resolution device to: obtain an access event, assess a situation, and resolve the access event based on the situation. In some variants, the physical access resolution device may additionally monitor the access event which may additionally include pre-access events and/or post-access events. The following discussion explores these steps in more detail.

At step 742, the physical access resolution device obtains an access condition (or pre-access condition, post-access condition, etc.). As previously noted, an “access event” is characterized by a person (or other entity e.g., drone, animal, etc.) attempting access to a physical space (zone) via a physical threshold. Events prior to the access event may be referred to as “pre-access events” and events after the access event may be referred to as “post-access events”. Conditions refer to information that may be evaluated to identify and distinguish between different e.g., pre-access events, access events, post-access events. For example, a sensor may detect a person approaching a house, putting on shoes and coat, etc. Depending on the detected conditions, the person pre-access event may be routine, anomalous, etc.

As previously alluded to, access events may be processed in distinct stages. Separating processing into different stages enables abstraction, obfuscation, and/or other processing methodologies. In one specific implementation, the physical access resolution device may obtain information about the access conditions in stages, with multiple sensors, etc. More generally, increasing access condition information leading-up-to, during, and following-after the access event (pre-access, access, and post-access) may be leveraged for a variety of different the situational awareness applications.

In one embodiment, the physical access resolution device senses data to detect the access condition. In one specific implementation, sensors may be staged as the access condition escalates toward an increasingly likely access event. For example, pre-access activity may be used to identify a number of subjects, classify a type of subjects, determine their speed and/or velocity (direction and magnitude), and/or other data collection and processing tasks in preparation of access attempts. The physical access resolution device proceeds to the next step when the likelihood of an access event exceeds a minimum confidence threshold.

In some embodiments, an array of different sensors may be used to collect multi-modal set of data regarding the access condition. Different sensor modalities may have different ranges, granularities, robustness, accuracy, and/or other predictive value. While any single sensor modality might be insufficient to detect an access event, their combined sensitivity may provide significantly higher confidence. Furthermore, confidence may also increase predictive behaviors accumulate (and decrease where behaviors are more anomalous). In one variant, confidence scores from one modality and/or stage may be statistically combined with other modalities and/or stages. Other implementations may use e.g., rule-based heuristics, machine learning, etc. As but one such example, an access condition may incorporate captured data from RF sensors, image sensors, microphones, etc.

In some embodiments, the sensed data may be captured across multiple zones and/or spaces. For example, an ingress and/or egress path may have multiple sensors with varying ranges of sensitivity and confidence. As another example, sensors may be located in different zones (exterior zone and interior zone). For example, exterior sensors may capture the approach of a person, while interior sensors monitor the occupants.

Certain access conditions may trigger additional processing and/or data collection. In some cases, the access conditions may incorporate e.g., system state. For example, the presence or absence of an occupant or a pet may affect the interpretation of a person coming to a door. Similarly, a person that takes a direct path to the front door may be viewed differently than a subject that appears to approach an open window or a garage that is open, etc.

In some variants, sensed data may be stitched together from different sensors to provide additional situational context. As but one such example, interior video may be stitched with exterior video to create a 360° video of the access event. As a similar example, audio tracks from the interior and exterior may be stitched together to generate a record of “dialog” or conversation spoken through a door. Still other variants may overlay e.g., visual information with infrared information, etc. Any technique for combinations, hybrids, and/or augmentations of different modalities of data may be substituted with equal success.

In other embodiments, data regarding an access condition may be received from another entity (e.g., a system administrator, a user device, a remote sensor, etc.). As but one such example, a person may call a user; the user may then approve the person. In some cases, the approval may be subject to certain access constraints (e.g., zone limitations, time duration, etc.). Additional constraints may be set by the user, so that the user does not need to actively monitor the access event and/or post-access. Still other access conditions may be scheduled, tracked, or triggered by other events (e.g., time of day, user input, location information, etc.). For example, a user may schedule a block of time for package delivery/in-home repair, etc. Here, the system may predict the corresponding access event, based on package tracking information, location tracking/estimated time of arrival, and/or local external information.

At step 744, the physical access resolution device assesses the situation. While various discussions throughout are presented in the context of specific examples, the concepts may be broadly extended to any situational assessment. Here, a situation refers to the set of conditions and/or events relevant to an access. Examples of relevant conditions and/or events may broadly include the physical environment, timing, resources, etc. In addition, the physical access resolution device considers the identity, actions, behaviors, and/or inferred intention of the entity(s) performing the access (e.g., person, people, animal(s), drone(s)/robot(s), etc.)

In one embodiment, the physical access resolution device uses a multi-modal assessment to identify a subject. In some embodiments, the subject explicitly provides an identity which is authenticated, validated, and/or verified by the physical access resolution device. Here, validation and its linguistic derivatives refers to processes that confirm that data is valid, whereas verification and its linguistic derivatives refers to processes that confirm that data is true. Validity and truth are distinct; e.g. a digitally signed certificate may be checked for validity against the signer's certificate—however, if the signer was compromised, then the signed data may still be malicious. Conceptually, an identity may be authenticated to varying degrees based on validation and/or verification of data. For example, a person may be explicitly authenticated by verifying a password challenge (binary, “hard” information), a person may also be implicitly authenticated to varying degrees of confidence by validating multiple layers of soft information (non-binary).

In some embodiments, assessment is performed according to a multi-layered assessment. In other words, a first level of confidence may trigger a first resolution, a second level of confidence may trigger a second resolution, etc. Thus, a very confident assessment may grant access and quiesce, whereas a less confident assessment may grant access but continue to monitor post-access activity. In other words, soft information may be used to tailor reactions to according to the level of confidence.

As discussed elsewhere, various embodiments of the present disclosure use statistical analysis and/or confidence metrics to assess soft information. More generally however, soft information may correspond to any gradation of assessment. In other words, while the various concepts are based on confidence-based identification, the concepts may be broadly extended to other forms of soft identification and/or confidence-based resolutions. For example, machine-learning techniques and/or heuristics may be substituted for identification with equal success.

More generally, situational awareness refers to any soft information that is inferred from explicitly known (hard) information associated with an access event. Explicitly known information is directly measured, sensed, captured, logically derived, or otherwise factually exists. Inferred information is assumed to have some probability of being accurate (and a corresponding probability of inaccuracy). Inferred information may be extrapolated, interpolated, learned from, and/or predicted based on explicitly known information.

At step 746, the physical access resolution device resolves access. Here, “resolutions” and its linguistic derivatives refers to one or more actions (and expected reactions) that the physical access resolution device will perform (and monitor), based on the assessed situation. In addition, the physical access resolution device may additionally continue to monitor the person's activity up-to, including, and/or after the access event (step 748). Conceptually, the physical access resolution device theorizes what the entity will do next and continues to monitor to adjust its resolutions accordingly.

In one embodiment, the physical access resolution device determines whether to enable/disable additional layers of authentication. In one such variant, the additional layers of authentication may be based on an underlying identity pack data structure that describes increasingly rigorous identity challenges. In some variants, the additional challenges may be pre-emptively launched as additional pre-access steps (e.g., as the person continues to approach the threshold, scrutiny is heightened). In other variants, the additional challenges may be enforced during the access event (e.g., the person affirmatively provides a password, prove a biometric, etc.). In still other variants, the additional challenges may continue to be launched post-access. This may be particularly useful where a person is provisionally granted access but may require additional monitoring. This may be useful with in-home delivery, residents with ongoing and/or recurrent behavioral and/or mental health issues, etc.

Examples of resolutions that may be performed may include e.g., granting/denying access, opening/closing (in whole or part) the physical threshold, continued monitoring, notifications to an administrator and/or external entities, etc. Various other resolutions may be substituted with equal success.

### 3.2 Coordination and Administration

Functionally, the system administration logic 800 coordinates and oversees the operation of the physical access resolution devices 700. For example, some access events may be informed by multiple physical access resolution devices (e.g., a secured residence means that all entrances are individually secured, a user may enter and exit at different thresholds, etc.). In other words, system-wide administration improves situational awareness.

System administration may be performed at a local networked resource, or virtualized and handled via cloud compute resources. Cloud services refer to software services that can be provided from remote data centers. Typically, cloud compute datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

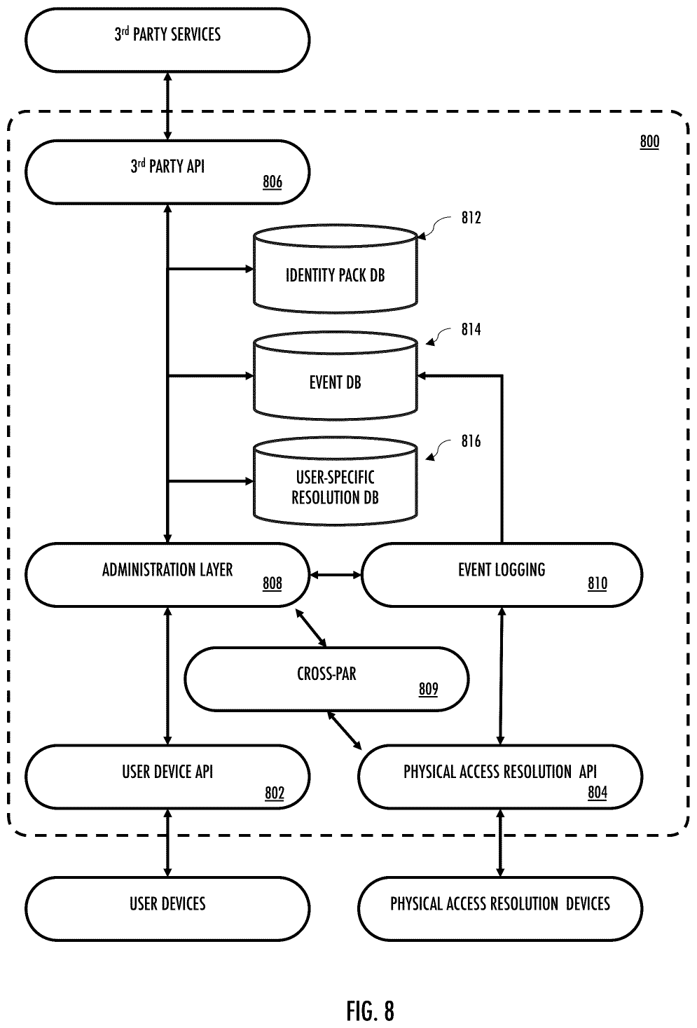

Here, the system administration logic 800 is subdivided into constituent services, rather than their physical implementation (which could be localized or cloud-based). FIG. 8 is a logical block diagram of the system administration logic 800. The system administration logic 800 includes: one or more application programming interfaces (APIs) (e.g., user device API 802, physical access resolution device API 804, and 3^{rd} party API 806), an administration layer 808, event logging 810, and one or more storages (e.g., identity pack database 812, event database 814, and resolution database 816, etc.). In some variants, the system administration logic 800 may additionally include cross-PAR communication logic 809.

Other system implementations may multiply, combine, further subdivide, augment, and/or subsume the foregoing functionalities within these or other logical nodes. For example, event logging may be locally stored at physical access resolution devices and/or archived within external cloud resources. Similarly, administration layer functionality may be handled in part, or whole, at other nodes of the system (e.g., user devices, physical access resolution devices, etc.).

An API (Application Programming Interface) is a set of rules and protocols that allows different software applications to communicate and interact with each other. It defines the methods, data formats, and conventions that enable access to, and functionality of, a software service, library, or platform. The illustrated implementation includes APIs to interact with the other components of the system. The user device API 802 enables communication with user devices (e.g., smart phones, laptops, etc.), the physical access resolution device API 804 monitors and controls the physical access resolution device operations, and 3^{rd} party API 806 may be used to further extend system functionality.

Conventional internet access APIs may be based on a server endpoint that supports one or more client endpoints. Generally, the server endpoint has a URL (which translates to an IP address) to send and receive requests and responses. Clients send and receive using HTTP methods e.g., GET, POST, PUT, DELETE. The responses are usually provided in computer-parsed formats (e.g., JSON, XML, etc.). The server and client endpoints may additionally support authentication and authorization, rate limiting, and error handling protocols. Artisans of ordinary skill in the related arts will readily appreciate that the server and client may coordinate via complementary function calls to implement very sophisticated logical interactions over the underlying API framework.

A storage is configured to structure and collect data in a manner that allows efficient storage, retrieval, and manipulation of information. Here, the illustrated implementation includes e.g. identity pack database 812, event database 814, and resolution database 816, etc.

The storage organizes data according to any number of relational schemas. Common examples of such schemas may associate data according to user, modality, time, location, metadata (extracted features, etc.). Queries may be made against the database, according to authorizations and/or other access control restrictions. For example, a user may query the database for their own data at a first level of access (unrestricted) but may have a reduced second level of access to other user's data. Other databases may be substituted with equal success. In some embodiments, the storage may be accessible via one or more of the APIs (with appropriate permissions, etc.).

The following discussions explore various aspects of the system administration logic 800 in greater detail.

The administration layer 808 manages and controls the configuration, users, policies, and overall operation of the system, and its component physical access resolution devices. The administration layer may be accessible via a user device, management portal, cloud service, and/or administrator interface.

Administration functionality may include, without limitation, user management, access control, system configuration, physical access resolution device configuration, user device access, etc. User management generally refers to the addition, modification, and removal of members. User management may additionally allow an administrator to define non-member handling, and/or other behavior (e.g., emergency behavior, etc.). Access control may define associated roles, privileges, restrictions, etc. for members and non-members; access control may include both physical and/or logical accesses. Configuration may include configuration of zones, times, access events, access conditions, and/or any other system or premises behavior. In some cases, this may additionally include configuration of individual physical access resolution devices and/or user devices. Various other administration-based functionality may be included, subsumed, augmented, and/or divided from this layer by artisans of ordinary skill in the related arts, given the contents of the present disclosure.

Event logging functionality records information about the access events, user actions, and other significant activities that occur within the system. Event logging may track e.g., timestamp, access event type, physical access resolution device, resolution(s), troubleshooting codes, confidence information (false positive, false negative, true positive, true negative, etc.), and/or associated data (e.g., images, audio, etc.)

In some embodiments, cross-PAR communication logic 809 enables physical access resolution devices to directly communicate with one another. In other embodiments, the system administrator logic may allow physical access resolution device to broadcast, multicast, or unicast their events to other entities. In some cases, this system feed may additionally enable user devices and/or 3^{rd} party applications to e.g., subscribe to network traffic and/or define and effectuate other events, resolutions, etc.

In one specific embodiment, the cross-PAR communication logic 809 may allow for abstraction and integration across layers. For example, sensor layer communications may communicate across peer devices at the sensor layer, assessment layer communications may communicate across peer devices at the assessment layer, etc. Thus, an assessment layer of one physical access resolution device may use sensor information from a different physical access resolution device, according to the abstraction schemes described elsewhere. For example, a physical access resolution device at an exterior door may assess its local situation (access event) based on data from other physical access resolution devices (to determine occupancy). In other words, abstraction allows each layer to integrate system-wide information from other devices.

The identity pack database stores data that may be used to validate, verify, and/or authenticate an individual, either directly or indirectly when combined with other data. Each identity pack may include e.g., biometric data (e.g., voice print, face print, finger print, gait, etc.), electronic and/or RF signatures (e.g., SIM ID, IMSI, etc.), behavioral data (e.g., personal habits, routines, schedule, etc.), explicit challenges (e.g., passcodes, PIN, etc.).

The event database stores event logging information, which may incorporate e.g., timestamp, access event type, physical access resolution device, resolution(s), troubleshooting codes, confidence information (false positive, false negative, true positive, true negative, etc.), and/or associated data (e.g., images, audio, etc.).

Resolution database stores a mapping of access events (pre-access events, post-access events, etc.), conditions, and their corresponding resolutions. Anecdotally, the number of different permutations that could be possible is likely too large for an administrator to conveniently wade through, thus the resolution database may be continuously updated with new mappings learned behaviors, according to administrator preferences, audit, and/or approval (such as may be collected from a user device, etc.).

As previously alluded to, individual physical access resolution devices will cache information from the storages (e.g., identity pack database 812, event database 814, and resolution database 816, etc.), to ensure that they can operate in “standalone” mode. Nonetheless, the shared storages may be used to synchronize behavior the devices. Furthermore, shared information may also be used to synchronize newly added devices to system state. Finally, certain types of information may require system-wide distribution; e.g., a “lockdown” may cause all physical access resolution devices to “lock” in anticipation of an imminent threat, similarly a “fire alarm” may cause all physical access resolution devices to “unlock” but also close doors (to slow the spread of fire), etc.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.
2.1. An apparatus, comprising:
   a first stage configured to capture to wake up a second stage when a first activity is detected within a first zone;
where the second stage is configured to capture a unique identifier, and where the second stage is configured to wake up a third stage when a second activity is detected within a second zone; and
where the third stage is configured to capture personally identifiable information, and
where the third stage is configured to perform access resolution based on the unique identifier and the personally identifiable information.
2.2. The apparatus of claim 1, where the first stage comprises motion detection.
2.3. The apparatus of claim 1, where the second stage comprises radio frequency sensors that collect the unique identifier.
2.4. The apparatus of claim 3, where the second stage is further configured to notify a subject that the unique identifier is being collected.
2.5. The apparatus of claim 4, where the second stage is further configured to discard the unique identifier when the subject backs away.
2.6. The apparatus of claim 1, where the third stage is further configured to record the unique identifier and the personally identifiable information for long-term archival.
2.7. The apparatus of claim 1, further comprising a fourth stage configured to trigger an intervention based on post-access activity.
2.8. A method, comprising:
   responsive to detecting a first activity within a first zone, capturing a unique identifier;
   responsive to detecting a second activity within a second zone, capturing personally identifiable information of a subject; and
   resolving access for the subject based on the unique identifier and the personally identifiable information.
2.9. The method of claim 8, further comprising idling a sensor or logic when no activity is detected in the first zone or the second zone.
2.10. The method of claim 9, further comprising waking up the sensor or the logic when activity is detected in the first zone or the second zone.
2.11. The method of claim 8, further comprising triggering an intervention based on post-access activity within a third zone.
2.12. The method of claim 8, further comprising notifying the subject when the unique identifier is captured.
2.13. The method of claim 8, further comprising notifying the subject when the personally identifiable information is captured.
2.14. The method of claim 8, further comprising associating the unique identifier and the personally identifiable information to the subject.
2.15. An apparatus, comprising:
   a first sensor configured to sense a subject within a first zone;
   a second sensor configured to collect a unique identifier within a second zone;
   a processor; and
   a non-transitory computer-readable medium comprising instructions that when executed by the processor, cause the apparatus to:
   wake up the second sensor when a subject is within the first zone; and
   capture the unique identifier when the subject is within the second zone.
2.16. The apparatus of claim 15, where the instructions further cause the apparatus to provide an alert when the subject is within the second zone.
2.17. The apparatus of claim 16, where the instructions further cause the apparatus to discard the unique identifier when the subject backs away.
2.18. The apparatus of claim 15, where the apparatus further comprises a third sensor configured to collect a personally identifiable information within a third zone, and where the instructions further cause the apparatus to wake up the third sensor when the subject is within the second zone.
2.19. The apparatus of claim 18, where the instructions further cause the apparatus to provide an alert when the subject is within the third zone.
2.20. The apparatus of claim 19, where the instructions further cause the apparatus to record the unique identifier and the personally identifiable information for long-term archival.
3.1. A method, comprising:
   capturing a first plurality of personally identifying information associated with a subject via a plurality of sensors;
   retrieving a second plurality of personally identifying information associated with a member from an identity pack;
   comparing the first plurality of personally identifying information to the second plurality of personally identifying information to obtain a confidence metric; and resolving an access event based on the confidence metric.
3.2. The method of claim 1, where the first plurality of personally identifying information comprises at least a first identifier having a first modality and a second identifier having a second modality, the second plurality of personally identifying information comprises at least a third identifier having the first modality and a fourth identifier having the second modality, and the confidence metric comprises a multi-modal confidence metric.
3.3. The method of claim 2, where the first modality is associated with a first confidence level and the second modality is associated with a second confidence level different than the first confidence level.
3.4. The method of claim 3, where the multi-modal confidence metric is obtained by comparing the first identifier to the third identifier based on the first confidence level and comparing the second identifier to the fourth identifier based on the second confidence level.
3.5. The method of claim 1, where resolving the access event comprises granting access when the confidence metric exceeds a confidence threshold to determine identity.
3.6. The method of claim 1, where resolving the access event comprises issuing an additional authentication challenge when the confidence metric falls below a confidence threshold to determine identity.
3.7. The method of claim 1, further comprising weighting at least one modality of the first plurality of personally identifying information based on environmental conditions.
3.8. The method of claim 1, further comprising checking that the first plurality of personally identifying information has a minimum quality for each modality of measurement.
3.9. The method of claim 1, further comprising checking that the first plurality of personally identifying information has a minimum number of modalities of measurement.
3.10. An apparatus, comprising:
   a first sensor associated with a first measurement modality;
a second sensor associated with a second measurement modality;
   a processor; and
   a non-transitory computer-readable medium comprising instructions that when executed by the apparatus, cause the apparatus to:
   capture a first personally identifying information of a subject from the first sensor;
   capture a second personally identifying information of the subject from the second sensor;
   obtain a set of identity packs associated with members of a group; and
   determine whether the subject is a member of the group to a multi-modal confidence level, based on the first personally identifying information, the second personally identifying information, and the set of identity packs.
3.11. The apparatus of claim 10, where the instructions further cause the apparatus to weight a first confidence level of the first measurement modality according to an environmental condition.
3.12. The apparatus of claim 10, where the apparatus further comprises a third sensor associated with a third measurement modality, and where the instructions further cause the apparatus to capture a non-personally identifying information via the third sensor, and where the multi-modal confidence level is not based on the non-personally identifying information.
3.13. The apparatus of claim 10, where the instructions further cause the apparatus to compare the multi-modal confidence level against a first confidence threshold and a second confidence threshold.
3.14. The apparatus of claim 13, where the instructions further cause the apparatus to monitor for one post-access activity based on the multi-modal confidence level exceeding the first confidence threshold and falling below the second confidence threshold.
3.15. The apparatus of claim 13, where the instructions further cause the apparatus to quiesce based on the multi-modal confidence level exceeding both the first confidence threshold and the second confidence threshold.
3.16. A system, comprising:
   a sensor layer configured to communicate with a plurality of sensors having a plurality of modalities;
   a situation assessment layer configured to assess a situation to a multi-modal confidence level, based on a set of captured data associated with the plurality of modalities; and
   an access resolution layer configured to determine access resolutions based on the situation.
3.17. The system of claim 16, where the set of captured data only contains a subset of the plurality of modalities.
3.18. The system of claim 16, where the plurality of sensors are associated with a plurality of physical access resolution devices.
3.19. The system of claim 18, where the situation is associated with a single physical access resolution device of the plurality of physical access resolution devices.
3.20. The system of claim 19, where the access resolution layer is further configured to determine the access resolutions based on the multi-modal confidence level and a first confidence threshold and a second confidence threshold.

What is claimed is:

1. A method, comprising:
obtaining an access condition;
assessing a situation based on the access condition;
resolving an access event to identify a resolution based on the situation; and
providing an application programming interface.

2. The method of claim 1, where obtaining the access condition comprises detecting a pre-access event.

3. The method of claim 2, where detecting the pre-access event comprises detecting a person within a zone.

4. The method of claim 3, where assessing the situation comprises identifying the person as a member or a non-member, based on an identity pack.

5. The method of claim 1, where obtaining the access condition comprises determining an occupancy of a zone during the access event.

6. The method of claim 1, where the resolution comprises determining whether to enable or disable an identity challenge.

7. The method of claim 1, where the resolution comprises determining whether to grant or deny access.

8. The method of claim 1, where the resolution comprises one or more post-access reactions.

9. The method of claim 1, where the application programming interface enables restricted access to an event log that records at least one of the access condition, the situation, or the resolution.

10. A system, comprising:
a sensor layer configured to communicate with sensors;
a situation assessment layer configured to assess a situation based on the sensor layer;
an access resolution layer configured to determine access resolutions based on the situation assessment layer; and
an application layer configured to control access to at least one of the sensor layer, the situation assessment layer, or the access resolution layer.

11. The system of claim 10, where the sensor layer is configured to obtain sensed data from multiple physical access resolution devices associated with multiple zones.

12. The system of claim 11, where the situation assessment layer is further configured to detect a first person attempting to access a physical threshold within a first zone, based on the sensed data associated with the first zone.

13. The system of claim 12, where the situation assessment layer is further configured to determine whether a second zone different than the first zone is occupied by a second person different than the first person.

14. The system of claim 10, where the situation assessment layer is further configured to assess the situation according to at least a first confidence level and a second confidence level.

15. The system of claim 14, where the access resolution layer is configured to trigger a first access resolution at the first confidence level, and trigger a second access resolution at the second confidence level.

16. A physical access resolution device, comprising:
a sensor;
a network interface;
a lock mechanism;
a processor; and
a non-transitory computer-readable medium comprising instructions that when executed by the processor, cause the physical access resolution device to:
sense first data via the sensor;
assess a situation based on the first data;
determine an access resolution based on the situation; and
communicate via the network interface.

17. The physical access resolution device of claim 16, further comprising a local identity pack data structure and where the situation is assessed based on the local identity pack data structure.

18. The physical access resolution device of claim 16, further comprising a local access plan data structure and where the access resolution is determined based on the local access plan data structure.

19. The physical access resolution device of claim 16, where the first data is further communicated to a sensor layer of a system via the network interface.

20. The physical access resolution device of claim 16, where the situation is further assessed based on second data communicated from a situation assessment layer of a system via the network interface.
